(19) United States
(12) Patent Application Publication
(10) Pub. No.: US 2024/0375057 A1
(43) Pub. Date: Nov. 14, 2024

(54) ANTI-SCALANT PROCESS FOR AN OSMOTIC UNIT

(71) Applicant: SALTPOWER HOLDING APS, Sønderborg (DK)

(72) Inventor: Lars Storm PEDERSEN, Sønderborg (DK)

(73) Assignee: SALTPOWER HOLDING APS, Sønderborg (DK)

(21) Appl. No.: 18/689,997

(22) PCT Filed: Sep. 9, 2022
(86) PCT No.: PCT/EP2022/075133

§ 371 Date: Mar. 7, 2024

(30) Foreign Application Priority Data
Sep. 10, 2021 (GB) 2112965.5

(51) Int. Cl. B01D 65/08; B01D 61/00

(52) U.S. Cl. CPC B01D 65/08; B01D 61/0022; B01D 61/0024; B01D 2313/18; B01D 2313/70; B01D 2317/04; B01D 2321/2033

(57) ABSTRACT

An osmotic process comprising for a first period, passing a draw stream and a feed stream through an osmotic unit having a semi-permeable membrane, permitting the passage of water but not salts. The feed stream is an aqueous stream with a lower salinity than the draw stream. The feed stream has a scalant with a concentration above saturation in a region on a feed side of the semi-permeable membrane. The draw stream passes over a draw side of the membrane and the feed stream passes over the feed side so water passes across the membrane from the feed stream to the draw stream. For a second time period, the flow rate of the draw stream is lower than the flow rate in the first time period, and the feed stream passes over the feed side such that the concentration of the scalant in said region is reduced.

### CROSS-REFERENCE TO RELATED APPLICATIONS

The present application is a U.S. National Stage Application of International Application No. PCT/EP2022/075133 filed Sep. 9, 2022 and published on Mar. 16, 2023 as WO2023/036943 Al, which claims benefit and priority of Great Britain Patent Application No. GB2112965.5 filed on Sep. 10, 2021, each of which is incorporated herein by reference in its entirety for any purpose whatsoever.

### FIELD OF THE DISCLOSURE

The present disclosure concerns scaling (also known as precipitation fouling) in osmotic membranes. More particularly, but not exclusively, this disclosure concerns an osmotic process, for example an osmotic power generation process, comprising an anti-scalant step.

### BACKGROUND OF THE DISCLOSURE

Osmotic processes include pressure retarded osmosis (PRO) and forward osmosis (FO). Such processes operate with two streams, a relatively low salinity feed stream and a relatively high salinity draw stream. The draw stream is passed over one side (the draw side) of a semi-permeable membrane that permits the passage of water but not salts, while the feed stream is passed over the other side (the feed side) of the membrane. Due to the difference in salinity between the feed and draw stream, water moves across the semi-permeable membrane from the feed stream to the draw stream.

Osmotic processes in accordance with the present disclosure rely on the difference in salinity of the two streams to drive the movement of water across the membrane. In contrast, reverse osmosis (RO) relies on a hydrostatic pressure difference to move solvent across the membrane against the concentration gradient. For that reason, and for the avoidance of doubt, reverse osmosis is not an osmotic process as that term is used herein.

As the draw and feed streams travel over the surface of the membrane their properties will change as water enters or leaves the stream via the membrane. The salinity of the draw stream is reduced with distance travelled over the membrane surface as water flows into the draw stream from the feed stream. Conversely, the concentration of solutes in the feed stream increases with distance travelled over the membrane as water flows out of the feed stream and into the draw stream. Thus, where scalant minerals (for example minerals containing the elements Si, Ca, Mg, Fe, Mn, and/or Ba) are present in the feed stream (and rejected by the membrane) their concentration is increased as the feed stream travels over the surface of the semi-permeable membrane. Typically the highest concentrations of scalant minerals (hereafter scalants) will be found in the output region of the feed side of the membrane (e.g. the region adjacent the outlet from the membrane). When levels of scalant minerals exceed saturation levels for the process conditions, scaling of the membrane may occur which impacts on the efficiency of the osmotic process. Membranes can be removed for descaling or cleaned in place (CIP) but this is time consuming and expensive. Accordingly, it would be advantageous to reduce the frequency at which descaling is required and/or eliminate the need for descaling.

Common methods for preventing scaling are to limit the flow across the membrane so that the concentration of any scalant mineral in the feed stream does not significantly exceed saturation. However for an efficient and/or economically viable osmotic process it is desirable to have a high level of water transfer across the membrane. Accordingly, it would be advantageous to provide an osmotic process which can operate and/or operate efficiently for longer periods with a feed stream having scalant concentrations in excess of saturation levels for the process conditions in one or more regions of the feed side of the membrane.

Antiscalants can be introduced into the feed stream upstream of the membrane in order to increase the saturation level at which precipitation will occur. However this increases pre-treatment costs and only provides a limited increase in the scalant concentration levels at which the process can operate.

In contrast to the above approaches which seek to slow the rate or reduce the risk of scaling, more recent developments have been focused on methods of cleaning membranes that have become fouled. U.S. Pat. No. 10,005,040 (MEMBRANE RECOVERY LTD) is an example of this approach and uses a reversal of the direction of flow of water across the membrane (flux) in combination with membrane shaking, for example via pulsed water stroke. The arrangement of U.S. Pat. No. 10,005,040 significantly increases the complexity of both the process and the systems with which it is carried out. It would be advantageous to provide a simpler method and apparatus that provides improved scaling performance in osmotic processes.

The present disclosure seeks to mitigate the above-mentioned problems. Alternatively or additionally, the present disclosure seeks to provide an improved osmotic process.

### SUMMARY OF THE DISCLOSURE

The present disclosure provides an osmotic process, the process comprising for a first time period, passing a draw stream and a feed stream through an osmotic unit (a first osmotic unit). The feed stream is an aqueous stream of lower salinity than the draw stream and having at least one scalant dissolved therein. The osmotic unit comprises a semi-permeable membrane which permits the passage of water but not the passage of salts. For the first time period, the draw stream passes over a draw side of the membrane and the feed stream passes over a feed side of the membrane so water passes across the membrane from the feed stream to the draw stream and the concentration of a scalant in the feed stream is above saturation in a region on the feed side of the semi-permeable membrane. For a second time period (e.g. throughout the second time period), the flow rate of the draw stream to the draw side of the membrane is lower than the flow rate at which the draw stream is provided to the draw side in the first time period and the feed stream passes over the feed side such that the concentration of the scalant in said region is reduced.

Thus, processes in accordance with the present disclosure include an anti-scalant step. During the anti-scalant step (the second time period), the feed stream is provided to the feed side of the membrane but the flow of fluid to the draw side of the membrane is reduced compared to the flow during normal operation (the first time period) such that the concentration of scalant on the feed side reduces.

Without wishing to be bound by theory, in the case that the flow of the draw stream to the draw side of the membrane is substantially stopped (i.e. substantially no flow is provided to the draw side), the flux of water across the membrane will continue but over time the remaining fluid on the draw side becomes more dilute as water continues to flow from the feed stream and accordingly the flux of water across the membrane ultimately reduces. Consequently, as the feed stream continues to pass over the feed side, less water is lost from the feed stream and the concentration of the scalant in said region is reduced. The present disclosure may provide advantages over simply increasing the flow rate of the feed stream because with that approach there will always be some loss of water across the membrane from the feed stream. In contrast, the present disclosure may allow the feed stream to have the same saturation level of a scalant at inlet and outlet from the membrane.

It will be appreciated that the concentration of said scalant may be reduced by decreasing rather than stopping the flow rate of the draw stream. When a single osmotic unit is being used, this allows the unit to remain in operation. Again, without wishing to be bound by theory, in the case that the flow rate of the draw stream is decreased, the residence time of the draw fluid on the draw side of the membrane will increase resulting in increased dilution of the draw fluid and a reduction of osmotic pressure at the outlet from the membrane. When the flow rate of the feed stream to the membrane is the same for the first and second time periods, this results in a decrease in the total flux across the membrane (i.e. the volume of fluid lost during passage between the inlet and outlet of the feed side) and consequently the concentration of the scalant in said region is reduced. It will be appreciated that a similar reduction in total flux may be achieved when the flow rate of the feed stream is not constant between the first and second time periods, provided the reduction in the flow rate of the draw stream is selected appropriately.

By reducing the concentration of the scalant, processes in accordance with the present disclosure may reduce the risk of scaling and/or rate at which scaling occurs. Further, process in accordance with the present disclosure may facilitate reduction of the concentration of the scalant in said region to below saturation (see discussion below).

Passing the feed stream over the membrane while the flow rate of the draw stream to the draw side of the membrane is at a reduced level(s) can be achieved simply in an osmotic system, for example by operating an additional valve located upstream of the draw side or controlling the operation of operation of a pump. Thus, processes in accordance with the present disclosure may reduce the risk and/or rate of scaling in a mechanically and operationally simple manner.

Additionally or alternatively, for a given flow rate of the feed stream provided to the membrane, the reduced loss of water from the feed stream across the membrane will result in an increased flow rate at outlet from the feed side of the membrane. This flushing effect may help to dislodge any scaling that has accumulated on the feed side of the membrane further reducing the risk of scaling and/or rate at which scaling occurs.

Additionally or alternatively, the reduction in flux across the membrane may reduce the suction on any foulant that has accumulated on the feed side of the membrane (sometime referred to as filter cake or fouling cake), allowing the feed stream to carry the foulant away, thereby reducing the risk of fouling and/or rate at which fouling occurs.

As used herein, the flow rate of a stream refers to the volumetric flow rate. It will be appreciated that ‘the flow rate at which the draw stream is provided to the draw side’ and ‘the flow rate of the draw stream to the draw side of the membrane’ refer to the flow rate of the stream at inlet to the draw side of the membrane.

As used herein, ‘feed stream’ refers to the stream that is passed to the feed side of the membrane and ‘draw stream’ refers to the stream that is passed to the draw side of the membrane. The flow rate at which the feed stream is provided to the feed side refers to the flow rate at which fluid is provided to the feed side. The flow rate at which the draw stream is provided to the draw side refers to the flow rate at which fluid is provided to the draw side.

It may be that the concentration of the scalant in the feed stream reduces by at least 5%, for example at least 10%, for example at least 20%, for example at least 50%, for example at least 75%. It may be that the concentration of the scalant in the feed stream in said region reduces to less than saturation. By way of example only, the process may operate in the first time period with a saturation index of 2 for an example scalant (e.g. silica) with 80% recovery. Recovery may be defined as (Fᵢₙ−Fₒᵤₜ)/Fᵢₙ, where Fᵢₙ is the flow rate of the feed stream on inlet to the membrane and Fₒᵤₜ is the flow rate of the feed stream on outlet from the membrane (also known as the bleed)). Closing the draw valve will (at equilibrium) therefore result in an 80% increase in the flow rate of the feed stream on outlet from the membrane and a corresponding 80% reduction in the amount of scalant—resulting in ⅕ the amount of scalant in said region following closure of the draw valve.

It may be that for at least part of the second time period, for example the majority and/or the whole of the second time period, the flow of the draw stream to the draw side is (substantially) stopped. That is to say, the flow rate of the stream to the draw side may be (substantially) zero.

Stopping the flow of fluid to the draw side of the membrane may be a particularly effective and/or quick way of reducing the concentration of scalant in the feed stream.

It may be that for at least part of the second time period, for example the majority and/or the whole of the second time period, the flow rate of the draw stream to the draw side of the membrane is reduced by at least 5%, for example at least 10%, for example at least 20%, for example at least 50% relative to the flow rate at which the draw stream is provided to the draw side in the first time period.

It may be that the passage of water across the membrane from the feed stream to the draw stream produces a dilute draw stream and for at least part of the second time period, for example the majority and/or the whole of the second time period, at least part of the dilute draw stream output from the membrane is recirculated to the draw side of the membrane such that the salinity of the draw stream provided to the draw side of the membrane is lower than the salinity of the draw stream during the first time period. This is discussed in more detail in the third aspect, below. It may be that the flow rate of the draw stream including said portion of the dilute draw stream and being provided to the draw side is lower than the flow rate at which the draw stream is provided to the draw side in the first time period.

The time it takes for scaling to occur in a process will depend in part on the level of each scalant mineral (hereafter scalant) in the feed stream. If the concentration of a particular scalant in the feed stream exceeds a certain threshold for the flow conditions precipitation will occur immediately. Below that threshold, a supersaturated feed stream will not start precipitating immediately, but instead precipitation will start after a delay which is known as the induction time. The induction time may be defined as the period of time required for a solution supersaturated with at least one scalant to begin to precipitate said at least one scalant. Without wishing to be bound by theory, it is believed that reducing the concentration of the scalant in the feed stream to below saturation (even briefly) resets the clock to zero for the purposes of the induction time. That is to say, if the concentration is reduced below saturation after a period of time less than the induction time then the induction time is never reached and precipitation does not occur. The induction time may be estimated experimentally by running an osmotic process at the intended flow conditions and without the anti-scalant step described herein. The period of time until precipitation onto the membrane surface occurs (as reflected by a drop in membrane water permeability) can then be measured to determine the induction time. Where reference is made to the induction time herein, that will be understood as the induction time calculated in this way.

It will be appreciated that a solution is saturated with a given solute when the maximum possible amount of solute is dissolved in the solvent. The addition of further solute to the solution results in a supersaturated solution and the formation of precipitate.

It may be that the flow rate of the draw stream to the draw side of the membrane remains (is kept) lower than the flow rate at which the draw stream is provided to the draw side in the first time period until the concentration of the scalant in the feed stream in said region is below saturation. This may provide a simple and effective way of resetting the clock on the induction time and thereby reduce the risk and/or rate of scaling.

It may be that the first time period is longer than the second time period. It may be that the first time period is less than the induction time for precipitation of the scalant in said region. It may be that the first time period is between 5 minutes and 25 hours in length. It may be that the second time period lasts for at least 15 seconds, for example at least 1 minute, for example at least 2 minutes. It may be the second time period lasts for a period of between 15 seconds and 15 minutes, for example between 15 seconds and 2 minutes. It will be appreciated that the appropriate time periods will depend upon the process conditions—in particular the saturation index and induction time for the specific scalant.

Additionally or alternatively, it may be that the flow rate of the draw stream to the draw side of the membrane remains (is kept) lower than the flow rate at which the draw stream is provided to the draw side in the first time period until the osmotic and hydraulic pressure across the membrane balances over at least a portion, for example the majority, of the surface of the membrane such that there is substantially no net flux across that portion of the membrane. This may provide a reduction in the amount of water lost from the feed stream as it passes through the osmotic unit and thereby lead to a reduction in the concentration of scalant in the feed stream thereby reducing the risk and/or rate of scaling.

It may be that the flow rate of the draw stream to the draw side of the membrane remains lower than the flow rate at which the draw stream is provided to the draw side in the first time period until the osmotic pressure across at least a portion, for example the majority, of the surface of the membrane is substantially zero such that there is substantially no net flux across that portion of the membrane. This may provide a reduction in the amount of water lost from the feed stream as it passes through the osmotic unit without the need to pressurize the streams and thereby lead to a reduction in the concentration of scalant in the feed stream in a more energy efficient manner.

It may be that the flow direction of the feed stream is reversed from a first direction to a second, opposite, direction, for example before, during or after the second time period.

It may be that the flow direction of the draw stream is reversed from a first direction to a second, opposite, direction, for example before during or after the second time period. Alternatively, it may be that the draw stream passes over the draw side of said membrane in a first direction during (throughout) said second time period.

It may be that during the second time period, the flow rate of the draw stream to the draw side of the membrane is lower than the flow rate at which the draw stream is provided to the membrane in the first time period and the feed stream passes over the feed side of said membrane in a first direction until the concentration of the scalant in the feed stream in said region is below saturation. Thus, the process may comprise reducing the flow rate of the draw stream while the feed stream is provided to the feed side in the same (e.g. first) direction and maintaining that arrangement until the concentration of the scalant in the feed stream in said region is below saturation.

This may provide a simple and effective way of resetting the clock on the induction time and thereby reduce the risk and/or rate of scaling. As discussed above, the attendant reduction in flux across the membrane may produce a flushing effect acts to removing scalant or other foulant from the surface of the membrane thereby increasing process efficiency.

Alternatively, it may be that during the second time period, the flow rate of the draw stream to the draw side of the membrane is lower than the flow rate at which the draw stream is provided to the membrane in the first time period and the feed stream passes over the feed side of said membrane in a first direction and then the flow direction of the feed stream is reversed from a first direction to a second, opposite, direction during the second time period such that the concentration of the scalant in said region is reduced to below saturation.

Reversing the flow direction of the feed stream is an effective way of reducing the concentration levels of a scalant in a region of the feed stream, however it risks causing precipitation in the short term. Immediately on reversing the flow, fluid located in the outlet region of the feed side (which typically has the highest levels of scalant concentration) will start to move back over the feed side of the membrane. If the salinity of that portion of fluid in the feed stream is still less than the salinity of the draw stream, water will continue to flow across the membrane from the feed stream to the draw stream further concentrating the feed stream and increasing the concentration level of any scalant therein. Thus, there is a risk that reversing the flow direction of the feed stream causes scalant concentrations to exceed the level for immediate precipitation to occur and consequently to increase the risk and/or rate of scaling. Reducing the flow rate of the draw stream, and in particular doing so before reversing the flow direction of the feed stream may reduce this risk and/or allow for flow reversal in processes with high concentrations of scalant in said region during normal operation.

It may be that the direction of the feed stream is reversed once the concentration of scalant in said region has reduced, for example below a predetermined threshold. It may be that the direction of the feed stream is reversed once the concentration of scalant in said region has reduced by more than 5%, for example by more than 10%, for example by more than 20% compared to the concentration of scalant in said region at the end of the first time period. It may be that the direction of the feed stream is reversed after a predetermined period of time has elapsed following the reduction in the flow rate of the draw stream to the draw side. Said predetermined period being selected such that the concentration of scalant in said region has reduced sufficiently such that the concentration of scalant in the fluid located in said region will not exceed a predetermined level (for example the level required for immediate precipitation) as said fluid passes over the feed side of the membrane in the opposite direction.

It may be that the flow rate of the draw stream returns (is returned) to the flow rate during the first time period at the end of the second time period. It may be that the first time period ends and the second time period begins when the flow rate of the draw stream is lowered.

It may be that for at least part of the second time period, for example the majority and/or the whole of the second time period the hydraulic pressure of the draw stream on the draw side is (substantially) unchanged from the pressure of the draw stream in the first time period. Pressure may be said to be substantially unchanged when the variation in pressure is less than plus or minus 1%. This may be particularly advantageous when the flow rate of the draw stream is reduced but not stopped. Maintaining the hydraulic pressure of the draw stream in that case prevents an increase in the flux across the membrane and the attended risk of saturation in said region exceeding the threshold for immediate precipitation.

In the case that the flow to the draw side is (substantially) stopped, the process may comprise for at least part of the second time period, the hydraulic pressure of the draw stream on the draw side being lower (being reduced to less) than the hydraulic pressure of the draw stream in the first time period. The hydraulic pressure may be reduced by at least 5%, for example at least 10%, for example at least 20% relative to the hydraulic pressure during the first time period.

The pressure of the draw side may be controlled by applying a pressure (hydraulic load) to the dilute draw stream, for example via a turbine if present.

The process may comprise, during the second time period (i) the flow rate of the draw stream to the draw side being maintained at (substantially) zero and (ii) the hydraulic pressure of the draw stream on the draw side being maintain at a lower level(s) than the hydraulic pressure of the draw stream in the first time period until the osmotic and hydraulic pressure across the membrane balance such that there is substantially no net flow across the membrane and the fluid on the draw side has a reduced salinity relative to the salinity of the fluid of the draw side throughout the first time period. Subsequently, the process may comprise increasing the flow rate of the draw stream (for example to the flow rate of the first time period) and/or increasing the hydraulic pressure of the draw stream (for example to the hydraulic pressure of the first time period) such that water passes across the membrane from the draw stream to the feed stream for a period of time. Said period of time may be at least 15 seconds, for example at least 30 seconds, for example at least 1 minute, for example at least 5 minutes. Said period of time may be shorter than the second time period and/or the first time period. Without wishing to be bound by theory, it is believed that reducing the hydraulic pressure of the draw stream when the flow of draw fluid is stopped results in the fluid on the draw side becoming sufficiently low that when the flow rate and hydraulic pressure are increased towards (or returned to) the levels of the first time period reverse osmosis occurs. This change in the direction of travel of water across the membrane may flush the membrane and assist with the removal of foulant and/or scalant from the membrane.

It may be that the flow rate of the draw stream is controlled using a draw valve, for example a single draw valve, such that a change in the position of the draw valve results in a change in the flow rate of the draw stream. Thus, the process may comprise operating a draw valve to lower and/or increase the flow rate of the draw stream. The draw valve may be a proportional control valve or a directional control valve. The process may comprise fully closing or switching the position of the draw valve to prevent the flow of draw fluid to the draw side. The process may comprise partially closing the draw valve to lower the flow of draw fluid to the draw side. The process may comprise fully or partially opening or switching the position of the draw valve to return the flow rate of the draw stream to its level during the first time period. The process may comprise the draw valve being in a first position for the first time period and then moving to a second position to reduce the flow rate of the draw stream at the start of the second time period. The process may comprise the draw valve being in the second position for the second time period.

The draw valve may be located upstream of the semi-permeable membrane. The draw stream may be located upstream of the osmotic unit, for example outside the housing of the osmotic unit on the flow path of the draw stream to the osmotic unit. Use of such a draw stream may allow the process to be carried out without needing to modify the osmotic unit. A single draw valve may be used during the first and second time periods (and any further time periods) to control the flow rate of the draw stream to the (first) osmotic unit.

It may be that flow rate of the draw stream is controlled using a pump, for example by varying the speed of operation of the pump. It may be that flow rate of the draw stream is controlled using an ERD (see below), for example by varying the increase in pressure provided by the ERD to the draw stream.

It may be that the pattern of a first time period followed by a second time period in which the flow rate of the draw stream is lower than the flow rate of the draw stream in the first time period is repeated, for example periodically. The pattern may be repeated at intervals of less than the induction time. It may be that the duration of each first time period is less than the induction time.

It may be that that the flow rate of the draw stream is substantially constant during the second time period. Alternatively, it may be that the flow rate of the draw stream varies during the second time period while remaining lower than the flow rate of the draw stream during the first time period.

It may be that that the flow rate of the feed stream to the feed side is kept (substantially) constant during the second time period. Alternatively, it may be that the flow rate of the feed stream varies during the second time period. It may be that the flow rate of the feed stream during the second time period is substantially equal to the flow rate of the feed during the first time period. It may be that for at least part of, for example the majority of or the whole of, the second time period the flow rate of the feed stream to the feed side is higher or lower than the flow rate of the feed stream during the first time period.

It may be that for at least part of the second time period, for example the majority and/or the whole of the second time period, the hydraulic pressure of the feed stream is lower than the hydraulic pressure of the feed stream during the first time period. It may be that for at least part of the second time period, for example the majority and/or the whole of the second time period, the hydraulic pressure of the feed stream is (substantially) unchanged from the hydraulic pressure of the feed stream during the first time period. It will be appreciated that increasing the hydraulic pressure of the draw and feed stream will impact on the flux across the membrane and care must be taken to choose an appropriate difference in hydraulic pressure across the membrane. The flow direction of the feed stream may be reversed from a first direction to a second, opposite, direction during the second time period. Alternatively, the flow direction of the feed stream may remain in the same (e.g. first) direction during the second time period. The flow direction of the feed stream may refer to the direction in which the feed stream passes over the membrane. For example, the feed stream may flow in a first direction from one or more first feed ports, to one or more second feed ports over the feed side of the membrane. Thus, when the feed stream flows in the first direction the first feed ports may be inlet ports and the second feed ports may be outlet ports. The feed stream may flow in a second, opposite direction, from said one or more second feed ports to said one or more first feed ports over the feed side of the membrane. Thus, when the feed stream flows in the second direction the first feed ports may be outlet ports and the second feed ports may be inlet ports.

Similarly, the draw stream may flow in a first direction from one or more first draw ports, to one or more second draw ports over the draw side of the membrane. Thus, when the feed stream flows in the first direction the first draw ports may be inlet ports and the second draw ports may be outlet ports. The draw stream may flow in a second, opposite direction, from said one or more second draw ports to said one or more first draw ports over the draw side of the membrane. Thus, when the draw stream flows in the second direction the first draw ports may be outlet ports and the second draw ports may be inlet ports

The second time period may be defined as a period of time during which the flow rate of the draw stream is at a reduced level or levels in comparison to the flow rate during the first time period. It may be that the second time period begins when the flow rate of the draw stream is lowered substantially below the flow rate in the first time period. It may be that the second time period ends when the concentration of the scalant in said region is reduced to below saturation. The first time period may be referred to as a period of ‘normal’ operation. The second time period may be referred to as an anti-scalant step.

It may be that the feed and/or draw stream are subject to one or more pre-treatment processes before it passes through the osmotic unit. Example pre-treatment processes include but are not limited to ion exchange, lime softening, ultrafiltration and/or nanofiltration. This may further reduce the risk and/or rate of scaling.

The region on the feed side of the membrane may be located in the region of the outlet of the feed stream from the feed side. For example, the region may extend from the outlet and over a portion of the surface area of the membrane. The region may extend over at least 5% of the surface area of the membrane. During the first and/or second time period, it may be that the highest concentration of the scalant on the feed side is found is said region. Thus, it may be that reducing the concentration of the scalant in said region to below saturation means that the concentration of the scalant in said region does not exceed saturation on the feed side of the membrane.

It may be that lowering the flow rate of the draw stream reduces the fluid pressure on the draw side of the membrane thereby creating a vacuum. The process may comprise part of a concentrated feed stream from one osmotic unit passing to the draw side of another osmotic unit under the action of such a vacuum.

The osmotic unit may comprise a plurality of semi-permeable membranes, for example hollow fibre membranes. The process may comprise for the first time period the draw stream passing over the draw sides of the membranes and the feed stream passing over the feed sides of the membranes so water passes across the membranes from the feed stream to the draw stream: and wherein the concentration of a scalant in the feed stream is above saturation in at one or more regions on the feed sides of the semi-permeable membranes (for example a region on the feed side of each membrane), and then during a second time period, the flow rate of the draw stream to the draw sides of the membrane is lower than the flow rate at which the draw stream is provided to the draw sides in the first time period and the feed stream passes over the feed sides such that the concentration of the scalant in at least one of said one or more regions (for example a region on the feed side of each membrane) is reduced.

The osmotic unit may comprise a housing. The or each membrane of the unit may be located within the housing. The osmotic unit may comprise a pair of draw ports (comprising a first draw port and a second draw port) in fluid communication with the draw side(s) of the membrane(s). The osmotic unit may comprise a pair of feed ports (comprising a first feed port and a second feed port) in fluid communication with the feed side(s) of the membrane(s). The osmotic unit may comprise one, two or more feed manifolds, each feed manifold being in fluid communication with the feed side of the membranes and a feed port. The osmotic unit may comprise one, two or more draw manifolds, each draw manifold being in fluid communication with the draw side of the membranes and a draw port.

The process may comprise, during the first time period, passing a draw stream and a feed stream through a second osmotic unit, the second osmotic unit comprising a second semi-permeable membrane which permits the passage of water but not the passage of salts, the draw stream passing over a draw side of the second membrane and the feed stream passing over a feed side of the second membrane so water passes across the membrane from the feed stream to the draw stream: and wherein the concentration of a scalant in the feed stream is above saturation in a region on the feed side of the second semi-permeable membrane, and wherein during the second time period, the flow rate of the draw stream to the draw side of the second membrane is (substantially) unchanged from the flow rate at which the draw stream is provided to the draw side of the second membrane in the first time period.

A flow rate may be said to be substantially unchanged when the difference in flow rate as between an previous and subsequent period (e.g. a first and second time period) is less than plus or minus 1% of the flow rate of the previous period.

The process may comprise after the second time period, during a third time period, the flow rate of the draw stream to the draw side of the first membrane being (substantially) unchanged from the flow rate at which the draw stream is provided to the draw side of the first membrane in the first time period and the flow rate of the draw stream to the draw side of the second membrane being lower than the flow rate at which the draw stream is provided to the draw side of the second membrane in the first and/or second time period and the feed stream passes over the feed side of the second membrane such that the concentration of the scalant in said region of the second membrane is reduced.

The process may comprise after the third time period, during a fourth time period, the flow rate of the draw stream to the draw side of the first membrane being (substantially) unchanged from the flow rate at which the draw stream is provided to the draw side of the first membrane in the first time period and the flow rate of the draw stream to the draw side of the second membrane is (substantially) unchanged from the flow rate at which the draw stream is provided to the draw side of the second membrane in the first time period.

Thus, the process may comprise operating two osmotic units in parallel such that one unit operates as normal, while an anti-scalant step is carried the other unit. Such a process may reduce the impact of the anti-scalant step on the overall outputs of the osmotic process.

This pattern of first, second, third and/or fourth time periods may be repeated, for example periodically. It may be that the total duration of the first, second and fourth time periods is less than the induction time for the second membrane. It may be that the total duration of the first, third and fourth time periods is less than the induction time for the second membrane. Features described above with respect to the (first) osmotic unit, may apply equally to the second osmotic unit. For example, there may be a second draw valve arranged to control the flow rate of the draw stream to the draw side of the second membrane.

The first and second osmotic units may be arranged in parallel. Osmotic units may be said to be in parallel when the draw stream is split upstream of the units, such that the draw stream received by one unit has not passed through the other unit(s).

Where the units are arranged in parallel, a single draw valve may be used to control the flow to the first and second osmotic units. Alternatively, it may be that a first draw valve controls the flow of draw fluid to the first osmotic unit and a second draw valve controls the flow of draw fluid to the second osmotic unit. The process may comprise operating further osmotic units in parallel to the first and second osmotic units.

The process may comprise one or more further osmotic units arranged in series with the first and/or second osmotic units (if present). Osmotic units may be said to be in series when the draw stream passes through one unit before passing through the other unit. The flow of draw fluid to each osmotic unit in a series may be controlled by the same valve. The process may comprise changing the position of a single valve and thereby varying the flow rate of the draw stream in all the osmotic units in a series. Such an arrangement may reduce the number of components required in the osmotic system in order to carry out the anti-scalant step.

It may be that the semi-permeable membrane is a hollow fibre membrane. The osmotic unit may comprise a plurality of said hollow fibres. Such hollow fibres are well known in the art. Each hollow fibre membrane may comprise an elongate hollow structure formed of the membrane material. The or each fibre may extend along a portion, for example the majority of the length of the osmotic unit. The fibres may be arranged around, for example wound around, a structure extending along the length of the unit, for example the centreline of the unit. The hollow fibres may be located in a region located between the structure and the housing of the unit. It may be that the feed side of each membrane is the inner surface of the membrane. It may be that the draw side of each membrane is the outer surface of the membrane. The region on the feed side of the membrane may extend inward from one end of the fibre along a portion of the length of the fibre. The region may extend inward from the outlet (downstream) end of the fibre. The net flow direction of the draw stream around the fibres may be substantially tangential to the longitudinal axes of the fibres over the majority of the length of the unit (cross-flow). For example, for the structure at the centre outwards. The net flow direction of the draw stream around the fibres may be substantially parallel to the longitudinal axes of the fibres over the majority of the length of the unit, and in the same direction as the feed stream (co-current) and/or in the opposite direction as the feed stream (counter-current). Where the flow direction is reversed, the process may comprise counter-current and co-current flow in the osmotic unit at different times.

The process may be operated with a recovery rate of between 40 and 98%. The recovery rate will depend at least in part on the salinity of the draw stream. The recovery rate may be defined as the difference in the flow rate of the feed between inlet and outlet to the feed side, divided by the flow rate of the feed on inlet to the feed side.

The process may comprise adding antiscalants to the feed stream before it passes over the feed side.

The process may comprise injecting cleaning agents (e.g. sodium hypochlorite) and/or disinfectant on the feed side while the valve on the draw side is closed. The effect of such agents and disinfectants may be enhanced when the valve is closed as the flux across the membrane is reduced.

The process may comprise carrying out pH adjustment on the feed stream before it passes over the feed side.

The process may comprise passing the feed stream through an oxygen scavenger before it passes over the feed side.

The process may comprise passing the feed stream over an ion exchange resin or membrane to exchange ions in the flow, before it passes over the feed side.

The salt content of the draw stream may be anything up to saturation. It may be that the salt content is at least 10% wt, for example at least 15% wt, for example at least 20 wt %. It will be appreciated that the draw stream may contain a wide variety of dissolved salts, comprising or with a preponderance of sodium chloride, potassium chloride and/or calcium chloride. “salt content” refers to total salt content. The exact nature of the salt(s) present in the draw stream is not important.

The feed stream may be obtained from any source, but is typically sea water, fresh or brackish water obtained, for example, from a river or a lake, or waste water obtained from an industrial or municipal source. The feed stream may be condensate produced during an industrial process. It will be appreciated that the salinity of the feed stream is less than the salinity of the draw stream. It may be that the salt content of the feed stream is 0 wt %. Alternatively, it may be that the feed stream contains salt(s) provided that the salinity of said stream is less than the salinity of the draw stream.

Alternatively or additionally, the draw stream and feed stream may comprise differing concentrations of organic molecules (e.g. organic compounds) so as to establish a difference in osmotic pressure across the semipermeable membrane. The organic molecules may, for example, comprise sugar, such as glucose. It will be appreciated that the concentration of the organic molecules in the feed stream is less than in the draw stream.

The flux of water across the membrane (the solvent flux) is defined as the mass of solute moving across the membrane from the feed stream to the draw stream per unit time. It may be that for at least part of the second time period, for example the majority and/or the whole of the second time period, the flux across the membrane is reduced by at least 5%, for example at least 10%, for example at least 20% relative to the flux across the membrane during (e.g. throughout) the first time period.

In a second aspect of the disclosure, there is provided an osmotic process, the process comprising, for example for a first time period, passing a draw stream and a feed stream through an osmotic unit, the feed stream being an aqueous stream of lower salinity than the draw stream and comprising at least on scalant (e.g. having at least one scalant dissolved therein), the osmotic unit comprising a semi-permeable membrane which permits the passage of water but not the passage of salts, the draw stream passing over a draw side of the semi-permeable membrane and the feed stream passing over a feed side of said membrane so water passes across the membrane from the feed stream to the draw stream and, the concentration of scalant in the feed stream is above saturation in a region on the feed side of the semi-permeable membrane, and then, for example for a second time period, stopping the flow of the draw stream to the draw side of the semi-permeable membrane and passing the feed stream over the feed side of the membrane until the osmotic and hydraulic pressure across the membrane balance such that there is substantially no net flow of water across the membrane.

Thus, the flow to the draw side may be stopped while the feed stream continues to pass over the feed side of the membrane until the flux across the membrane becomes zero. As water no longer leaves the feed stream, the concentration of scalant will drop to the level found on entry to the feed side, for example a level below saturation. At the same time, the flow rate at outlet from the feed side is increased, thereby providing a flushing effect that enhances the reduction in scaling or fouling. Thus, processes in accordance with the present disclosure may provide an improved osmotic process.

The process of the second aspect may include any of the features described above with reference to the first aspect or third aspects (and vice versa) except where such features are clearly incompatible.

The process may further comprise, after the osmotic and hydraulic pressure across the membrane balance, reversing the flow direction of the feed stream over the feed side of the semi-permeable membrane from a first direction to a second, opposite, direction. It may be that said reversal in flow direction occurs while the flow of the draw straw stream is stopped.

In a third aspect, the present disclosure provides an osmotic process, the process comprising for a first time period, passing a draw stream and a feed stream through an osmotic unit (e.g. a first osmotic unit). The feed stream is an aqueous stream of lower salinity than the draw stream and comprising at least one scalant (e.g. having at least one scalant dissolved therein). The osmotic unit comprises a semi-permeable membrane which permits the passage of water but not the passage of salts. For the first time period the draw stream passes over a draw side of the membrane and the feed stream passes over a feed side of the membrane so water passes across the membrane from the feed stream to the draw stream thereby producing a dilute draw stream; and wherein the concentration of a scalant in the feed stream is above saturation in a region on the feed side of the semi-permeable membrane. For a second time period (e.g. throughout the second time period), at least part of the dilute draw stream is provided to the draw side of the membrane (for example passed from the outlet of the draw side of the membrane to the inlet of the draw side of the same membrane) such that the salinity of the draw stream provided to the draw side in the second time period is lower than the salinity of the draw stream provided to the draw side in the first time period and the feed stream passes over the feed side such that the concentration of the scalant in said region is reduced.

Thus, processes in accordance with the present disclosure include an anti-scalant step. During the anti-scalant step (the second time period), the feed stream is provided to the feed side of the membrane but the salinity of the draw fluid provided to the draw side of the membrane is reduced compared to the salinity of the draw fluid provided to the draw side during normal operation (the first time period) by recirculating at least part of the dilute draw stream to the draw side of the membrane. The process of the third aspect may include any of the features described above with reference to the first aspect or second aspects (and vice versa) except where such features are clearly incompatible.

Without wishing to be bound by theory, the reduced salinity on the draw side achieved by mixing or replacing the draw stream with the dilute draw fluid results in a reduced flux of water across the membrane. Consequently, less water is lost from the feed stream and the concentration of the scalant in said region is reduced.

By reducing the concentration of the scalant, processes in accordance with the present disclosure may reducing the risk of scaling and/or rate at which scaling occurs. Further, process in accordance with the present disclosure may facilitate reduction of the concentration of the scalant in said region to below. Providing (for example recirculating) at least part of the dilute draw stream to the draw side of the membrane can be achieved simply in an osmotic system, for example by operating an additional valve located on a flow path between the outlet from the membrane and the inlet to the membrane. Thus, processes in accordance with the present disclosure may reduce the risk and/or rate of scaling in a mechanically and operationally simple manner.

Additionally or alternatively, for a given flow rate of the feed stream provided to the membrane, the reduced loss of water from the feed stream across the membrane will result in an increased flow rate at outlet from the feed side of the membrane. This flushing effect may help to dislodge any scaling that has accumulated on the feed side of the membrane further reducing the risk of scaling and/or rate at which scaling occurs.

Additionally or alternatively, the reduction in flux across the membrane may reduce the suction on any foulant that has accumulated on the feed side of the membrane (sometime referred to as filter cake or fouling cake), allowing the feed stream to carry the foulant away, thereby reducing the risk of fouling and/or rate at which fouling occurs.

It may be that for at least part of the second time period, for example the majority and/or the whole of the second time period the salinity of the draw stream provided to the draw side in the second time period is reduced by at least 5%, for example at least 10%, for example at least 20% relative to the salinity of the draw stream provided to the draw side in the first time period.

It may be that for at least part of the second time period, for example the majority and/or the whole of the second time period at least 5%, for example at least 10%, for example at least 20%, for example at least 50% of the dilute draw stream output from a membrane is recirculated to the inlet of the membrane.

The process may comprise mixing at part of the dilute draw stream with the draw stream provided to the osmotic unit and passing the resulting stream to the draw side of the membrane. Alternatively, the process may comprise diverting the draw stream provided to the osmotic unit and instead providing at least part of the dilute draw stream to the draw side of the membrane.

In a fourth aspect of the disclosure there is provided an osmotic system, for example an osmotic power generation system, configured to carry out the process of the first, second and/or third aspects.

The power generation system may comprise a connection to a draw stream and/or a reservoir (suitable for) containing draw fluid. The power generation system may comprise a connection to a feed stream and/or a reservoir (suitable for) containing feed fluid. The power generation system may comprise an osmotic power unit arranged to generate power (for example electricity) through Pressure Retarded Osmosis (PRO) using the difference in salinity between the feed and draw streams.

The osmotic power unit may comprise at least one osmotic unit. The osmotic power unit may comprise a plurality of osmotic units. The osmotic power unit may comprise a draw manifold arranged to provide the draw stream from the connection and/or reservoir to each osmotic unit. The osmotic power unit may comprise a feed manifold arranged to provide the feed stream from the connection and/or reservoir to each osmotic unit. The or each osmotic unit may comprise a spiral wound membrane, a plate and frame membrane, a plurality of hollow fibres (e.g. the membrane may be a hollow fibre membrane) and/or any other type of suitable membrane arrangement.

The or each osmotic unit may comprise a membrane having a draw side and a feed side. Fluid forming part of the stream passing over the draw side or feed side of the membrane may be said to be ‘on’ the draw side or feed side respectively. The osmotic unit may comprise a least one draw inlet via which fluid is provided to the draw side. The osmotic unit may comprise a least one draw outlet via which fluid exits from the draw side after passage over the membrane. The osmotic unit may comprise a least one feed inlet via which fluid is provided to the feed side. The osmotic unit may comprise a least one feed outlet via which fluid exits from the feed side after passage over the membrane.

The osmotic power unit may comprise one or more draw valves. The osmotic power unit may comprise a draw valve configured to control the flow rate of the draw stream to at least two osmotic units. The osmotic power unit may comprise a first draw valve configured to control the flow rate of the draw stream to at least two osmotic units arranged in series (e.g. with at least one output from the first unit being used as the input to a second unit) and a second draw valve configured to control the flow rate of the draw stream to at least two other osmotic units. The osmotic units associated with the second draw valve may be arranged in parallel to the osmotic units associated with the first draw valve (e.g. with the draw stream being divided between the osmotic units associated with the first draw valve and the osmotic units associated with the second draw valve).

The osmotic power unit may comprise an energy recovery device (ERD). The ERD may comprise a pressure exchanger. It may be that the ERD (or the pressure exchanger) is configured to increase the pressure of a lower pressure stream (for example the draw stream prior to passage through the osmotic power unit) using a higher pressure stream (for example at least a portion of the draw stream after passage through the osmotic unit).

The osmotic power unit may comprise at least a recirculation valve assembly comprising one or more valves. The recirculation valve assembly may be configured to provide a flow path for at last part of the dilute draw stream to the inlet of the draw side of the membrane. The recirculation valve assembly may be configured control the flow of dilute draw stream to the draw side of the membrane by opening and/or shutting one or more of said valves. The recirculation valve assembly may be arranged to divert at least some of the dilute draw stream away from the ERD (if present) and to the inlet of the draw side.

The osmotic power unit may comprise a feed valve assembly comprising one or more valves. The feed valve assembly may be configured to switch the direction of flow of the feed stream from a first direction to a second, opposite, direction by opening and/or shutting one or more of said valves.

The osmotic power unit may comprise one or more pumps arranged to pressurise the draw stream and/or the feed stream.

The osmotic power unit may comprise a turbine and/or generator arranged to convert pressure of flow generated by movement of water across the membrane into power (e.g. electricity).

The osmotic system may comprise a control system configured to effect a change in the configuration of the osmotic system in order to carry out the method of the first, second, third or any other aspects as described above or below: The control system may be configured to change the configuration of the osmotic system in order to lower the flow rate at which the draw stream is provided to the draw side in the first time period in accordance with the first aspect: and/or stop the flow of the draw stream to the draw side in accordance with the second aspect: and/or provide at least part of the dilute draw stream to the draw side of the membrane in accordance with the third aspect. The control system may be configured to operate one or more valves, for example to change the state or position of one or more valves, in the osmotic system. For example, the control system may be configured to operate a first, second or other draw valve, one or more valves of said recirculation valve assembly, and/or one or more valves of the feed valve assembly. The control system may be configured to operate said valves in order to operate the osmotic system in accordance with the first, second or third aspects as described above. The control system may be configured to operate other elements of the osmotic power unit, for example said one or more pumps to pressurise the draw stream and/or the feed stream. The control system may be configured to operate the turbine and/or generator. The control system may comprise one or more sensors arranged to measure a property of the feed or draw stream. The control system may be configured to effect said change in configuration in respect to a user or other input, for example an input from said sensors. The control system may be configured to effect said change in configuration in accordance with a pre-determined time schedule. The control system may comprise software or other machine-readable instructions that when executed cause the control system to change the configuration of the osmotic system in order to carry out the method of the disclosure. The control system may comprise one or more processors or other conventional computing hardware on which such software or machine-readable instructions can be executed. The control system may comprise electronic control circuitry of the type known in the art to enable the execution of said software or other machine-readable instructions to cause changes in the configuration of the osmotic system.

It will of course be appreciated that features described in relation to one aspect of the present disclosure may be incorporated into other aspects of the present disclosure. For example, the method or process of the disclosure may incorporate any of the features described with reference to the apparatus of the disclosure and vice versa.

### DESCRIPTION OF THE DRAWINGS

Embodiments of the present disclosure will now be described by way of example only with reference to the accompanying schematic drawings of which:

FIGS. 1 shows a first example process according to the disclosure at a first time;

FIG. 2 shows the process of FIG. 1 at a second, later, time;

FIG. 3 shows the process of FIG. 1 at a third, later, time

FIGS. 4 to 10 show a second example process according to the disclosure, each figure showing the process at a different point in time;

FIG. 11 shows a cross-sectional view of an example osmotic unit suitable for use in the first and second example processes;

FIG. 12 shows another cross-sectional view of the osmotic unit of FIG. 11;

FIG. 13 shows a third example process according to the disclosure at a first time; and

FIG. 14 shows a flow chart of an example method according to the disclosure.

### DETAILED DESCRIPTION

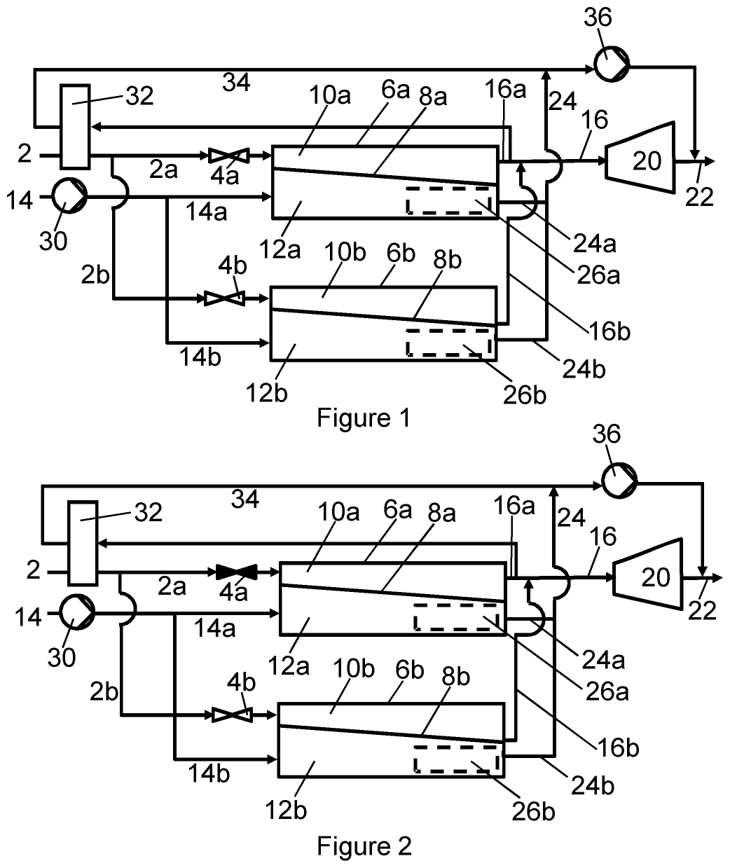

FIG. 1 shows a schematic illustration of an example process in accordance with the disclosure at a first time. In FIG. 1, a draw stream 2 splits into two draw stream branches 2a and 2b. The first draw stream branch 2a passes through a first draw valve 4a to a first osmotic unit 6a. The second draw stream branch 2b passes through a second draw valve 4b to a second osmotic unit 6b. Each of the first and second osmotic unit 6a, 6b comprises a semi-permeable membrane 8a, 8b, each semi-permeable membrane 8a, 8b having a draw side 10a, 10b (to which the draw stream 2 is passed) and a feed side 12a, 12b. A feed stream 14 splits into two branches 14a and 14b. The first and second feed stream branches 14a, 14b are passed to the feed side 12a, 12b of the first and second osmotic units 6a, 6b respectively. First and second dilute draw stream branches 16a, 16b are output from the draw side 10a, 10b of the first and second osmotic units 6a, 6b respectively. First and second concentrated feed stream branches 24a, 24b are output from the feed side 12a, 12b of the first and second osmotic units 6a, 6b respectively. In FIG. 1, the first and second dilute draw stream branches 16a, 16b are recombined as dilute draw stream 16 and passed through a turbine 20 to produce an output stream 22, which is disposed of as appropriate, and electricity. In other embodiments, the turbine 20 may be absent and/or the dilute draw stream branches 16a, 16b may not be recombined before disposal and/or passing through a turbine. In FIG. 1, the first and second concentrated feed stream branches 24a, 24b are recombined as concentrated feed stream 24 which is disposed of as appropriate. In other embodiments, the first and second concentrated feed stream branches 24a, 24b may not be recombined. The system of FIG. 1 may be said to have two osmotic units arranged in parallel. In FIG. 1, a check valve 30 is provided on feed stream 14 upstream of the split into first and second feed stream branches 14a, 14b. In other embodiments this check valve may be absent.

In FIG. 1 a portion of the dilute draw stream 16a upstream of the turbine 20 passes through a pressure exchanger 32 as the high pressure stream and the draw stream 2 passes through the pressure exchanger 32 as the low pressure stream before splitting into the first and second draw stream branches 2a, 2b. After passing through the pressure exchanger 32 the reduced pressure draw stream 34 passes through a check valve 36 before being recombined with output stream 22 from the turbine 20.

In use, during normal operation, the first and second draw valves 4a, 4b are open as shown in FIG. 1 and the draw stream 2a, 2b and feed stream 14a, 14b flows over the draw and feed sides of the semi-permeable membrane 8a, 8b in each osmotic unit 6a, 6b. The draw stream 2 has a higher salinity than the feed stream 14. Due to the difference in salinity between the draw stream 2a, 2b and feed stream 14a, 14b, water passes from the feed stream 14a, 14b to the draw stream 2a, 2b. Thus, the concentration of any mineral scalant in the feed stream 14a, 14b increases as the feed stream passes through the osmotic unit 6a, 6b. In order to attain an efficient osmotic process, the system is operated such that in a region 26a, 26b on the feed side of the membrane 8a, 8b, the concentration of the scalant exceeds saturation for the process conditions. Example scalants include minerals of the elements Si, Ca, Mg, Fe, Mn, Ba.

If the process continues as shown in FIG. 1 for a period greater than the induction time then precipitation will occur in region 26a, 26b, leading to scaling of the membrane. Accordingly, from time to time, and at a time interval of less than the induction time, the first draw valve 4a is shut, while the second draw valve 4b remains open-this configuration is shown in FIG. 2. In FIG. 2, the flow to the second osmotic unit 6b is unchanged from FIG. 1, but closure of the first draw valve 4a stops the flow of the first draw branch 2a to osmotic unit 6a. Hydraulic pressure on the draw side of the membrane is maintained, for example using turbine 20. After closure of the first draw valve 4a the flow of water across the semi-permeable membrane 8a results in the salinity of the fluid on the draw stream side being substantially equal to that of the feed stream—i.e. the osmotic pressure becomes substantially zero—and there is substantially no net flow of water across the semi-permeable membrane. Accordingly, after an initial period of adjustment, the concentration of scalant in the feed stream 14a no longer increases as it passes through osmotic unit 6a, and the concentration of scalant in the region 26a is reduced to the level found in the feed stream 14a on entry to the feed side, which is below saturation. This resets the clock for the induction time in this region thereby reducing the risk and/or rate of scaling. Further, for a given flow rate of the feed stream 14a provided to the membrane 8a in FIG. 1 and FIG. 2 configurations, the output flow of the feed stream 14a will be increased in FIG. 2 as compared to FIG. 1, because water is no longer being lost across the membrane 8a. Thus, processes in accordance with the present example may provide a flushing on the feed side which further reduces the risk and/or rate of scaling. The first draw valve 4a is kept closed for a second time period, which in some embodiments is between 1 and 15 minutes.

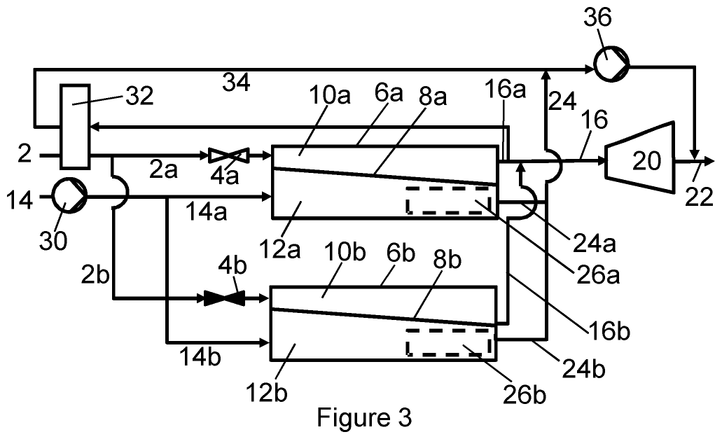

After the second time period, the first draw valve 4a is reopened and the second draw valve 4b is closed, as shown in FIG. 3. The first osmotic unit 6a now operates as shown in FIG. 1. As for the first osmotic unit 6a during the second time period, the concentration of scalant in the feed stream 14b no longer increases as it passes through osmotic unit 6b, and the concentration of scalant in the region 26b is reduced to below saturation. This resets the clock for the induction time in the region 26b thereby reducing the risk and/or rate of scaling. The second draw valve 4b is kept closed for a third time period, which in some embodiments is between 1 and 15 minutes.

After the third time period, the second draw valve 4b is reopened and the system is operated in the configuration shown in FIG. 1.

This process is repeated regularly during operation. To reduce the risk and/or rate of scaling, the time period between each closure of the first draw valve 4a and the time period between each closure of the second draw valve 4b is less than the induction time for the region of highest scalant concentration. In some embodiments, the interval between each closure of a valve is between 5 minutes and 24 hours depending on the process parameters. Because two osmotic streams are provided in the process of FIG. 1, the system continues to produce electricity (using one of the osmotic units 6) while the anti-scalant process is carried out on the other osmotic unit 6). Thus, processes in accordance with the present examples may advantageously allow continuation of the osmotic process while reducing the risk and/or rate of scaling. Additionally or alternatively, processes in accordance with the present examples may reduce fouling on the feed side: the reduction of flow across the membrane may reduce the suction on any foulant built up on the feed side thereby allowing it to be flushed out of the unit. Additionally or alternatively, processes in accordance with the present examples allow an anti-scaling process to be carried out by simply opening and closing a draw valve, thereby providing anti-scaling in a mechanical simply manner.

A control system (not shown) controls the opening and closing of the valves based on the period of time elapsed in any one state. In other embodiments, the control system changes the state of the valves in response to the input from one or more sensors that measure flow conditions in the system. In yet further embodiments, the valves could be operated manually by a user.

FIG. 1 shows two osmotic streams, each stream having a draw valve 4 located upstream of a single osmotic unit 6. In other embodiments, a single osmotic stream may be used. In yet further embodiments, additional osmotic units may be present in series with the first and/or second osmotic units-for example with a single draw valve 4 located upstream of two or more osmotic units 6. In such embodiments, the dilute draw stream output from an osmotic unit may be used as the draw stream for the next unit in the stream. That is to say, the osmotic units a stream are arranged in series. In that way, a single draw valve may be used to stop the flow of draw fluid to all osmotic units in the stream.

FIG. 1 shows the feed and draw streams running in a co-current configuration (in the same direction through the unit), in other embodiments the feed and draw streams may run counter current.

Processes in accordance with the present example may provide increased energy efficiency as pressure is transferred from the dilute draw stream 16 to the draw stream 2 by the pressure exchanger 32, thereby reducing the need for mechanical pumping. However, in other embodiments, pressure exchanger 32 may be absent.

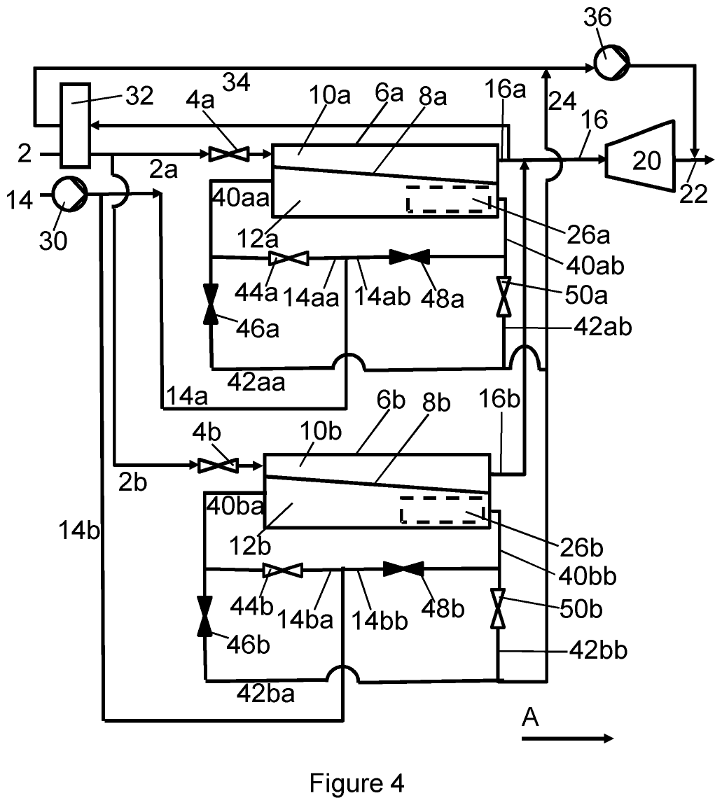

FIG. 4 shows another example process in accordance with the disclosure. Only those aspects of the FIG. 4 example that differ from the process of FIGS. 1 to 3 will be described here. Like elements are indicated with like reference numerals as between FIGS. 1 and 4 (e.g. the first osmotic unit is indicated with the reference numeral 6 in both figures). In contrast to FIG. 1, the process of FIG. 4 permits reversal of the feed flow 14. The first feed stream branch 14a further splits into two sub branches 14aa, 14ab. Sub branch 14aa itself splits into an input/output stream 40aa which is connected to one end of the feed side of the osmotic unit 6a and a return stream 42aa which connects to the reduced pressure draw stream 34. A first valve 44a is located on sub branch 14aa. A second valve 46a is located on the return stream 42aa. Sub branch 14ab splits into an input/output stream 40ab which is connected to the other end of the feed side of the osmotic unit 6a and a return stream 42ab which connects to the reduced pressure draw stream 34. A third valve 48a is located on sub branch 14ab. A fourth valve 50a is located on the return stream 42ab. This structure is repeated for the second feed stream branch 14b and the second osmotic unit 6b.

In use, during the first time period, the first and second draw valves 4a, 4b are open. The first valves 44a, 44b and fourth valves 50a, 50b are open and the second valves 46a, 46b and third valves 48a, 48b are closed. The feed stream passes through the osmotic unit 6a, 6b from left to right in FIG. 4 (indicated by the arrow A).

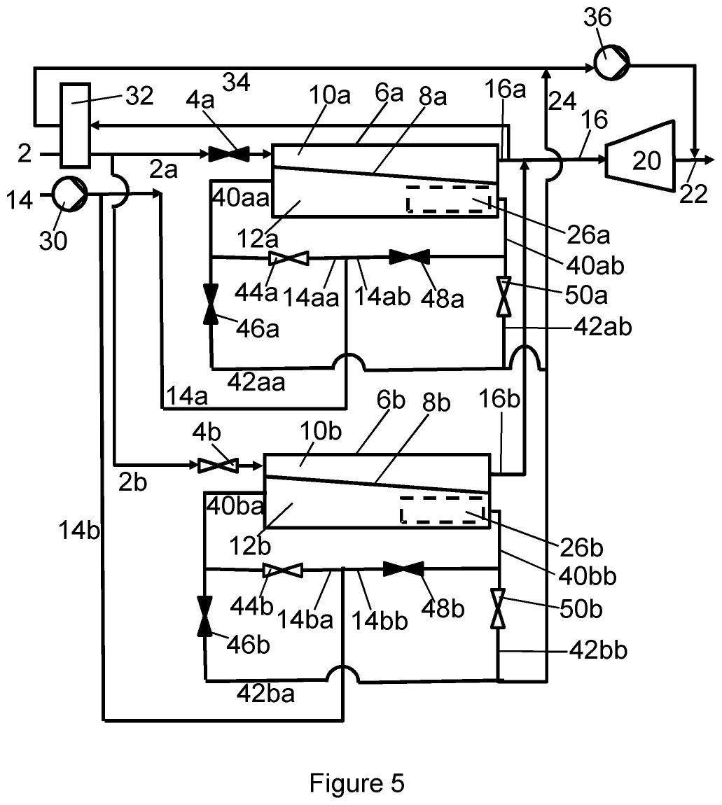

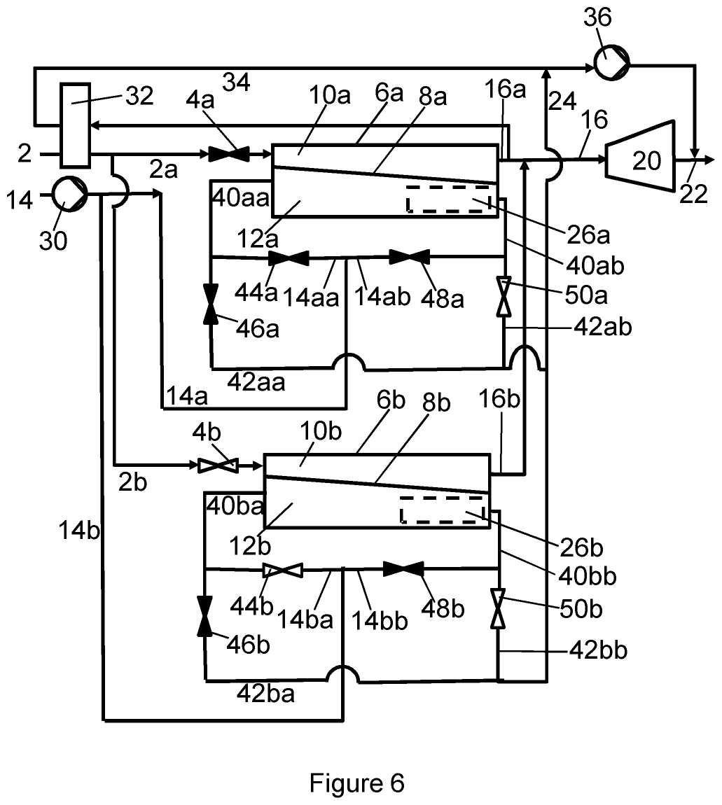

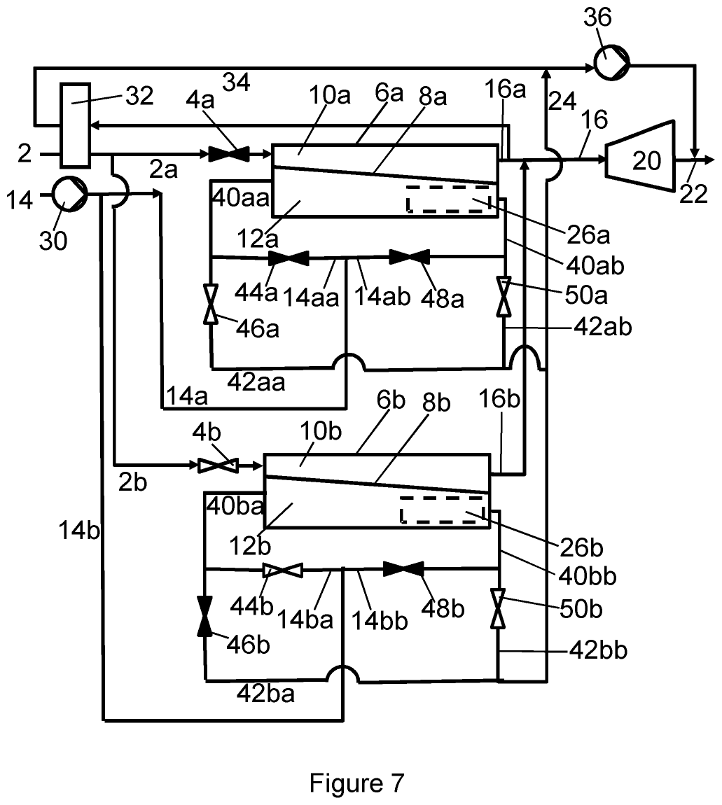

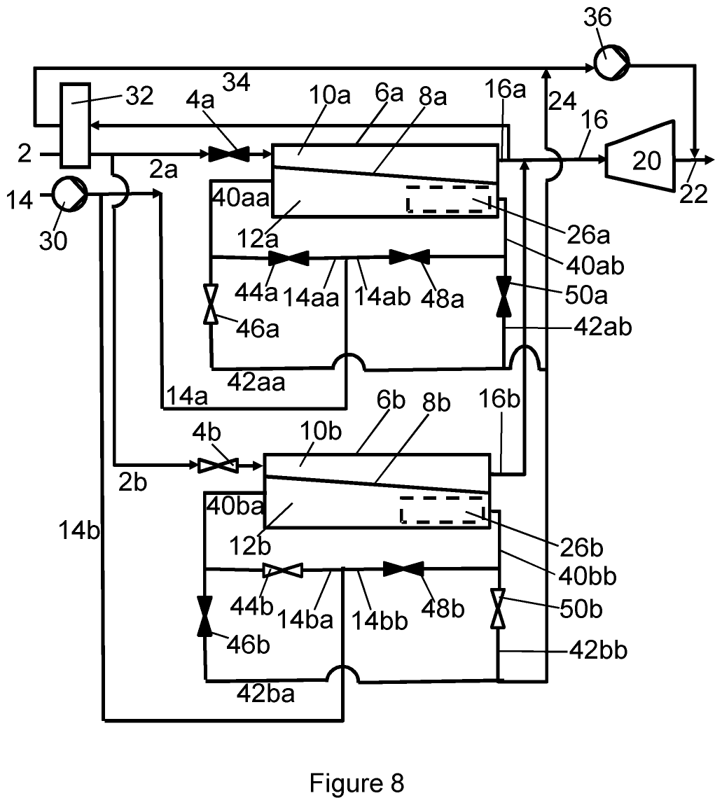

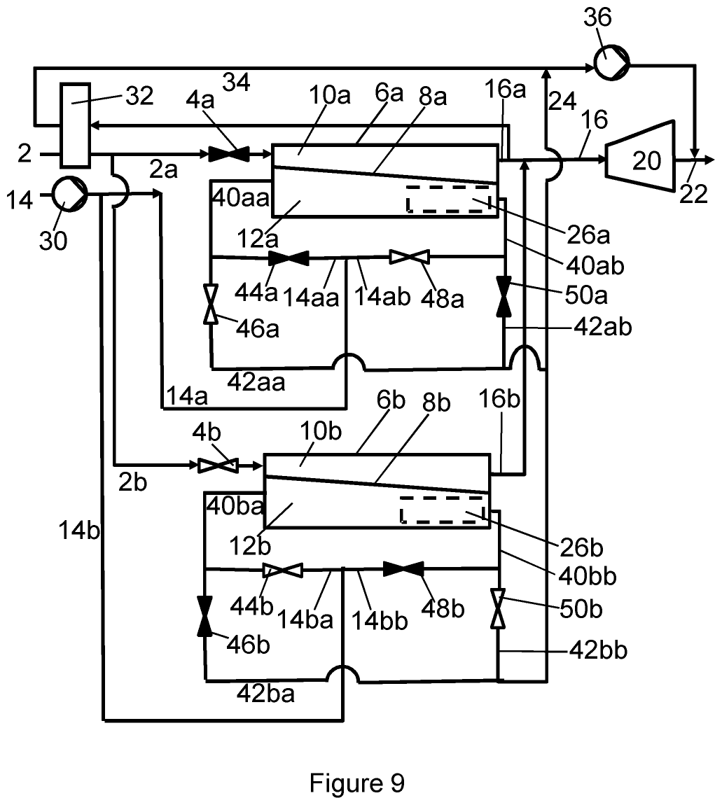

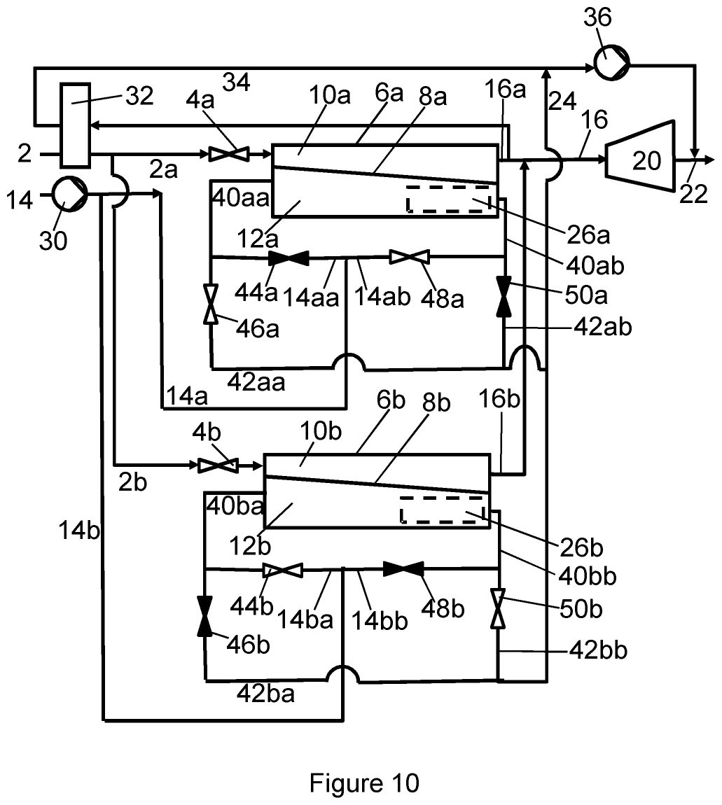

After the first time period, the first draw valve 4a is shut. This configuration is shown in FIG. 5. As described above in connection with FIG. 2, the concentration of scalant in the feed stream 14a no longer increases as it passes through osmotic unit 6a, and the concentration of scalant in the region 26a is reduced to below saturation. The first valve 44a is then shut (see FIG. 6). The fourth valve 50a remains open allowing any suction from the draw side of osmotic unit 6a to be compensated from the outlet of the feed side of the second osmotic unit 6b via return stream 42bb. Then the second valve 46a is opened (see FIG. 7), followed by closing of the fourth valve 50a (see FIG. 8) and then opening of the third valve 48a (see FIG. 9) which completes reversal of the direction in which the feed stream 14a flows through the first osmotic unit 6a. After a further time period, the first draw valve 4a is reopened (see FIG. 10) so that the osmotic process recommences as in FIG. 4 but with the feed stream 14a flowing in the opposite direction. The osmotic unit 6a is operated in this counter current mode until the first draw valve 4a is next closed. The anti-scaling process for the second osmotic unit 6b, which is not illustrated in the Figures, can then be started by shutting draw valve 4b and then operating the first 44b, second 46b, third 48b and fourth 50b valves to reverse the feed stream flow in the same manner as described for the first osmotic unit 6a. While FIGS. 4 to 10 describe flow reversal being carried out with a particular valve arrangement it will be appreciated that other valve arrangements may be used.

In other example processes (not shown) the direction of the draw stream may be reversed.

In the embodiments of FIGS. 1 to 10 as described above, the draw valves 4a, 4b are shut during the anti-scalant process, so that flow of the draw stream to the draw side of the semi-permeable membrane 8a, 8b is prevented. In other embodiments, the draw valve 4a, 4b may be only partially closed. In such embodiments the residence time of the draw fluid on the draw side increases, leading to more dilute draw fluid at outlet from the membrane (reduced osmotic pressure at outlet) and a corresponding reduction in fluid crossing the membrane from the feed stream to the draw stream.

In some embodiments where the draw valves 4a, 4b are shut during the anti-scalant process the hydraulic pressure of the draw stream 2a, 2b is reduced (for example to ˜ 60 bar) while the corresponding draw valve 4a, 4b are closed. When normal operation is resumed (i.e. valves 4a, 4b are reopened and the hydraulic pressure of the draw stream returns to ˜70 bar) there will be a brief period when water flows across the membrane from the draw stream 2a, 2b to the feed stream 14a, 14b. Process in accordance with the present embodiments may therefore provide an additional flushing of the membrane 8a, 8b.

It will be appreciated that the flux across the membrane is a consequence of (all other factors being equal) the balance of hydraulic and osmotic pressure between the draw and feed stream. In order to prevent an excess of flux across the membrane from the feed stream (and the attendant risk of immediate precipitation) it will not generally be desirable to reduce the hydraulic pressure of the draw stream significantly, for example to atmosphere.

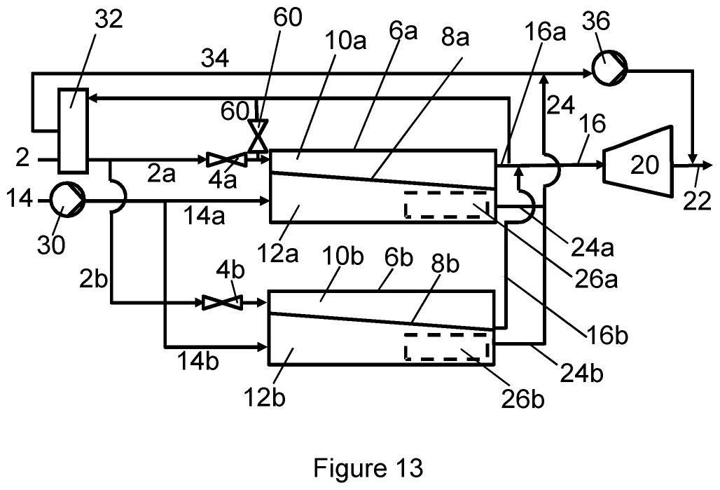

FIG. 13 shows another example process in accordance with the disclosure. Only those aspects of the FIG. 13 example that differ from the process of FIGS. 1 to 3 will be described here. Like elements are indicated with like reference numerals as between FIGS. 1 and 13 (e.g. the first osmotic unit is indicated with the reference numeral 6 in both figures). In contrast to FIG. 1, the process of FIG. 13 includes a recirculation valve 60 on a recirculation path 62 which branches of the flow path taken by the dilute draw stream 16a output from the first osmotic unit 6a to the pressure exchanger 32. The recirculation path 62 connects the dilute draw stream 16a to the first draw stream branch 2a upstream of the osmotic unit 6 and downstream of the first draw valve 4a.

In use, during normal operation, the recirculation valve is closed and the process operates as described above for FIG. 1. In order to prevent precipitation, from time to time and at a time interval of less than the induction time, the recirculation valve 60 is opened. This allows part of the dilute draw stream 16a to mix with the fluid in the first draw stream branch 2a resulting in the solution passed to the draw side of the osmotic unit 6a having a lower salinity than the draw fluid during normal operation. This reduction in salinity on the draw side leads to a reduction in the flux across the membrane from the feed side to the draw side and for a large enough reduction in salinity the concentration of scalant in the region 26a is reduced below saturation. This may be carried out at the same time as closing or partially closing the first draw valve 4a. Alternatively, in some embodiments the first draw valve 4a may be absent and the drop in scalant concentration in the region 26a may be achieved solely by recirculation of the draw fluid. Thus, processes in accordance with the present example may reduce the risk and/or rate of scaling. Further, for a given flow rate of the feed stream 14a the output flow will be increased when the recirculation valve 60 is open because less water is being lost across the membrane. Thus, processes in accordance with the present example may provide a flushing on the feed side which further reduces the risk and/or rate of scaling. The recirculation valve 60 is only shown and described in connection with the first osmotic unit 6a in FIG. 13 but it will be appreciated that each osmotic unit 6 in the process may be provided with such a recirculation valve (in combination with a draw valve 4 or as an alternative to the draw valve 4).

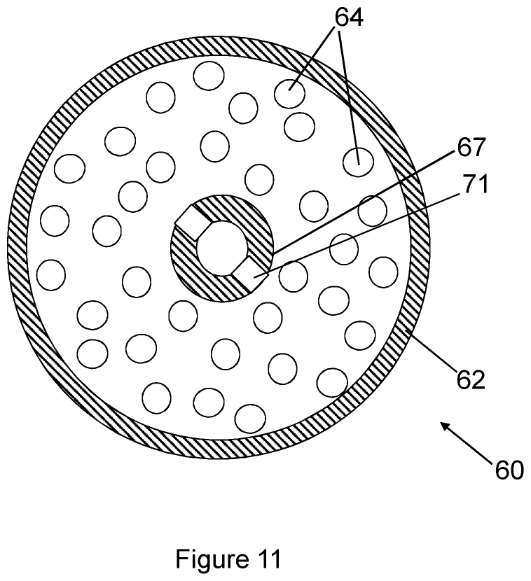

FIG. 11 shows a cross sectional view of an osmotic unit 60 suitable for use as the osmotic unit 6 of FIGS. 1 to 10 and 13. The cross-section is taken perpendicular to the longitudinal axis of the unit. Within a cylindrical casing 62 (which appears circular when viewed in cross-section in FIG. 11) are a plurality of hollow fibres 64 (which appear circular when viewed in cross-section in FIG. 11), the walls of which are made of a semi-permeable membrane material which permits the passage of water but not salts. The hollow fibres 64 are wound around a hollow central tube 67 which has apertures 71 extending through its side walls from the inside of the tube 67 to the outside.

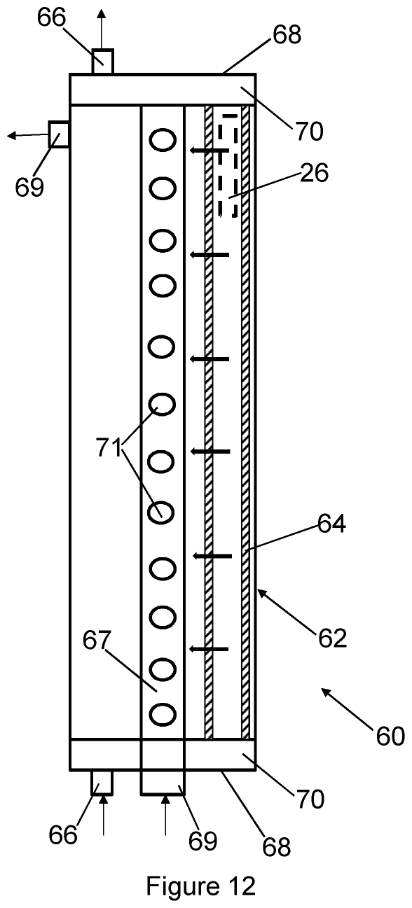

FIG. 12 shows a cross sectional view of the osmotic unit of FIG. 11. The cross-section is taken parallel to the longitudinal axis of the unit. For clarity, only one hollow fibre 64 is shown in FIG. 12 and it is shown with its centreline extending parallel to the longitudinal axis of the unit 60. It will be appreciated that in reality a plurality of hollow fibres 64 are present, and their centreline may be non-parallel with the longitudinal axis of the unit. A pair of feed ports 66 are located in the closed ends 68 of the casing 62. One draw port 69 is located at the centre of a closed end 68 (the lower end in FIG. 12) and connects to the central tube 67 which extends along the length of the casing 62 and has a plurality of apertures 71 spaced apart along its length. Another draw port 69 is located on the outer circumference of the casing 62 at the other end of the unit 60 (the upper end in FIG. 12). A manifold 70 is provided at each end of the unit and connects the feed port 66 to the inlet end of each hollow fibre 64.

In use, the draw stream 2 flows between the draw ports 69 via the central tube 67, apertures 71 and around the outside of the hollow fibres 64. The feed stream flows between the feed ports 66 and along the inside of the hollow fibres 64 via manifolds 70. The direction of flow for both the feed and draw stream is from top to bottom in FIG. 12. The difference in salinity between the feed stream and the draw stream causes water to move across the walls of the hollow fibres 64 (i.e. across the semi-permeable membrane) thereby diluting and increasing the pressure of the draw stream. That increase in pressure may then be used to do useful work, for example to drive an electricity generating turbine. With distance along the hollow fibre 64 the concentration of any scalant present in the feed stream is increased as water is lost from the feed stream across the membrane. Thus, the concentration of scalant is highest in a region 26 extending from the outlet end of the hollow fibre 64. For efficiency, it is desirable to have high flow across the membrane, leading to the feed stream being supersatured in the region 26. To reduce the risk and/or rate of scaling, the supply of draw fluid to the osmotic unit is stopped or reduced from time to time, at intervals of less than the induction time. It will be appreciated that for a plurality of fibres the concentration of scalant in the region 26 of each fibre may vary but the time interval for interrupting the supply of draw fluid may be determined based on the worst case.

FIGS. 11 and 12 show the draw stream flow radially outward from a central structure (a cross-flow arrangement). In other example osmotic units (not shown) both draw ports may be arranged on the outer circumference of the casing 62 and the unit may be operated in a co-current or counter-current arrangement.

While FIGS. 11 and 12 show a hollow fibre osmotic unit, it will be appreciated that in other embodiments a spiral wound osmotic unit may be provided. In yet further embodiments, other forms of osmotic unit may be used. The disclosure may find application wherever an osmotic process operates with a region of supersaturated stream.

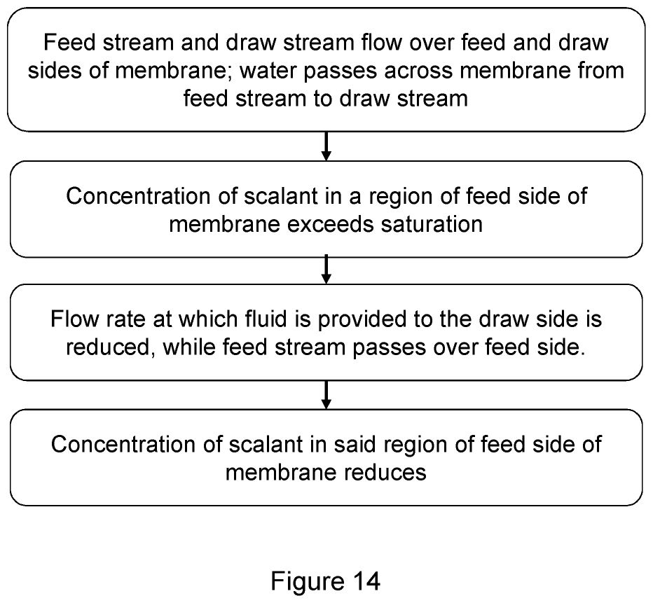

FIG. 14 shows a flow chart of an example process according to the disclosure. During a first time period a feed stream passes over the feed side of a semi-permeable membrane while a draw stream passes over the draw side of the semi-permeable membrane so that water passes across the membrane from the feed stream to the draw stream and the concentration of a scalant is above saturation in a region on the feed side of the semi-permeable membrane. Then, the flow rate at which the draw stream passes over the draw side (the flow rate of the draw stream to the draw side) is reduced. While the flow of fluid to the draw side is reduced, the feed stream passes over the feed side such that the concentration of scalant is reduced. Optionally, the flow of fluid to the draw side is stopped (i.e. the flow rate of the draw stream to the draw side is substantially zero). Optionally, the feed stream passes over the feed side at the same flow rate during both the first and second time periods. Optionally, the direction of flow of the feed stream over the feed stream is reversed during the second time period. Optionally, the flow rate of the draw stream over the draw side returns to the same rate as during the first time period at the end of the second time period. Optionally, this process of reducing the flow of fluid to the draw side of the membrane is performed periodically, for example at intervals of less than the induction time.

Whilst the present disclosure has been described and illustrated with reference to particular embodiments, it will be appreciated by those of ordinary skill in the art that the disclosure lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

1. An osmotic process, the process comprising. for a first time period, passing a draw stream and a feed stream through an osmotic unit, the feed stream being an aqueous stream of lower salinity than the draw stream and comprising at least one scalant, the osmotic unit comprising a semi-permeable membrane which permits the passage of water but not the passage of salts, the draw stream passing over a draw side of the membrane and the feed stream passing over a feed side of the membrane so water passes across the membrane from the feed stream to the draw stream; and wherein the concentration of a scalant in the feed stream is above saturation in a region on the feed side of the semi-permeable membrane, and then for a second time period, the flow rate of the draw stream to the draw side of the membrane is lower than the flow rate at which the draw stream is provided to the draw side in the first time period and the feed stream passes over the feed side such that the concentration of the scalant in said region is reduced.

2. The process according to claim 1, wherein for at least part of the second time period the flow rate of the draw stream to the draw side of the membrane is substantially zero.

3. The process according to claim 1, wherein the passage of water across the membrane from the feed stream to the draw stream produces a dilute draw stream and for at least part of the second time period, at least part of the dilute draw stream output from the membrane is recirculated to the draw side of the membrane such that the salinity of the draw stream provided to the draw side of the membrane is lower than the salinity of the draw stream during the first time period.

4. The process according to claim 1, wherein the flow rate of the draw stream to the draw side of the membrane remains lower than the flow rate at which the draw stream is provided to the draw side in the first time period until the concentration of the scalant in the feed stream in said region is below saturation.

5. The process according to claim 1, wherein during the second time period the feed stream passes over the feed side in a first direction until the concentration of the scalant in the feed stream in said region is below saturation.

6. The process according to claim 1, wherein the direction in which the feed stream passes over the feed side is reversed from a first direction to a second, opposite, direction during the second time period such that the concentration of the scalant in said region is reduced to below saturation.

7. The process according to claim 1, wherein the flow rate of the draw stream to the draw side of the membrane remains lower than the flow rate at which the draw stream is provided to the draw side in the first time period until the osmotic and hydraulic pressure across the membrane balances over at least a portion of the surface area of the membrane.

8. The process according to claim 1, wherein the flow rate of the draw stream to the draw side of the membrane remains lower than the flow rate at which the draw stream is provided to the draw side in the first time period until the osmotic pressure across at least a portion of the surface area of the membrane is substantially zero.

9. The process according to claim 1, wherein the first time period is less than the induction time for precipitation of the scalant in said region, and/or wherein the or each first time period lasts for at least 5 minutes and/or the or each second time period lasts for at least 15 seconds for example at least 30 seconds.

10. The process according to claim 1, wherein the flow rate of the draw stream returns to the flow rate during the first time period at the end of the second time period; and/or wherein the flow rate at which the feed stream is provided to the feed side is kept substantially constant throughout the second time period.

11. (canceled)

12. The process according to claim 1 wherein the pattern of a first time period followed by a second time period in which the flow rate of the draw stream is lower than the flow rate of the draw stream in the first time period is repeated periodically.

13. (canceled)

15. The process according to claim 1, wherein the semi-permeable membrane is a hollow fibre membrane, plate and frame, or a spiral wound membrane.

16. The process according to claim 1, wherein during the second time period (i) the flow rate of the draw stream to the draw side is maintained at (substantially) zero and (ii) the hydraulic pressure of the draw stream on the draw side is maintained at a lower level(s) than the hydraulic pressure of the draw stream in the first time period until the osmotic and hydraulic pressure across the membrane balance such that there is substantially no net flow across the membrane; and then,
the process comprises increasing the flow rate of the draw stream and/or increasing the hydraulic pressure of the draw stream such that water passes across the membrane from the draw stream to the feed stream for a period of time.

17. (canceled)

18. The process according to claim 1, further comprising:
during the first time period, passing a draw stream and a feed stream through a second osmotic unit, the second osmotic unit comprising a second semi-permeable membrane which permits the passage of water but not the passage of salts, the draw stream passing over a draw side of the second membrane and the feed stream passing over a feed side of the second membrane so water passes across the second membrane from the feed stream to the draw stream; and wherein the concentration of a scalant in the feed stream is above saturation in a region on the feed side of the second semi-permeable membrane, and wherein
during the second time period, the flow rate of the draw stream to the draw side of the second membrane is substantially unchanged from the flow rate at which the draw stream is provided to the draw side of the second membrane in the first time period; and then
during a third time period, the flow rate of the draw stream to the draw side of the first membrane being substantially unchanged from the flow rate at which the draw stream is provided to the draw side of the first membrane in the first time period and the flow rate of the draw stream to the draw side of the second membrane being lower than the flow rate at which the draw stream is provided to the draw side of the second membrane in the first and/or second time period and the feed stream passes over the feed side of the second membrane such that the concentration of the scalant in said region of the second membrane is reduced.

19. The process according to claim 18, wherein after the third time period, during a fourth time period, the flow rate of the draw stream to the draw side of the first membrane is substantially unchanged from the flow rate at which the draw stream is provided to the draw side of the first membrane in the first time period and the flow rate of the draw stream to the draw side of the second membrane is substantially unchanged from the flow rate at which the draw stream is provided to the draw side of the second membrane in the first time period.

20. An osmotic process, the process comprising:
passing a draw stream and a feed stream through an osmotic unit, the feed stream being an aqueous stream of lower salinity than the draw stream and comprising at least one scalant, the osmotic unit comprising a semi-permeable membrane which permits the passage of water but not the passage of salts, the draw stream passing over a draw side of the semi-permeable membrane and the feed stream passing over a feed side of said membrane so water passes across the membrane from the feed stream to the draw stream; and wherein the concentration of scalant in the feed stream is above saturation in a region on the feed side of the semi-permeable membrane, and then
stopping the flow of the draw stream to the draw side of the semi-permeable membrane and passing the feed stream over the feed side until the osmotic and hydraulic pressure across the membrane balance such that there is substantially no net flow across the membrane.

21. The osmotic process according to claim 20, further comprising, after the osmotic and hydraulic pressure across the membrane balance, reversing the flow direction of the feed stream over the feed side of the semi-permeable membrane from a first direction to a second, opposite, direction.

22. (canceled)

23. An osmotic process, the process comprising:
for a first time period, passing a draw stream and a feed stream through an osmotic unit, the feed stream being an aqueous stream of lower salinity than the draw stream and comprising at least one scalant, the osmotic unit comprising a semi-permeable membrane which permits the passage of water but not the passage of salts, the draw stream passing over a draw side of the membrane and the feed stream passing over a feed side of the membrane so water passes across the membrane from the feed stream to the draw stream thereby producing a dilute draw stream;
and wherein the concentration of a scalant in the feed stream is above saturation in a region on the feed side of the semi-permeable membrane, and then for a second time period, providing at least part of the dilute draw stream to the draw side of the membrane such that the salinity of the draw stream provided to the draw side in the second time period is lower than the salinity of the draw stream provided to the draw side in the first time period and the feed stream passes over the feed side such that the concentration of the scalant in said region is reduced.

24-28. (canceled)

29. An osmotic system configured to carry out the osmotic process of claim 1, the osmotic system comprising the osmotic unit and one or more of:
at least one draw valve arranged to control the flow rate of the draw stream to the draw side of the membrane;
a feed valve assembly comprising one or more valves, the feed valve assembly being operable to switch the direction of flow of the feed stream from a first direction to a second, opposite, direction by opening and/or shutting one or more of said valves;
a recirculation valve assembly comprising one or more valves, the recirculation valve assembly being operable to control the flow of at least part of the dilute draw stream to the inlet of the draw side by opening and/or shutting one or more of said valves; and
a control system configured to effect a change in the configuration of the osmotic system in order to: lower the flow rate at which the draw stream is provided to the draw side in the first time period in accordance with claim 1; and/or stop the flow of the draw stream to the draw side in accordance with claim 1.

30. An osmotic system configured to carry out the osmotic process of claim 20, the osmotic system comprising the osmotic unit and one or more of:
at least one draw valve arranged to control the flow rate of the draw stream to the draw side of the membrane;
a feed valve assembly comprising one or more valves, the feed valve assembly being operable to switch the direction of flow of the feed stream from a first direction to a second, opposite, direction by opening and/or shutting one or more of said valves;
a recirculation valve assembly comprising one or more valves, the recirculation valve assembly being operable to control the flow of at least part of the dilute draw stream to the inlet of the draw side by opening and/or shutting one or more of said valves; and
a control system configured to effect a change in the configuration of the osmotic system in order to: lower the flow rate at which the draw stream is provided to the draw side in the first time period in accordance with claim 20; and/or stop the flow of the draw stream to the draw side in accordance with any of claim 20.

31. An osmotic system configured to carry out the osmotic process of claim 23, the osmotic system comprising the osmotic unit and one or more of:
at least one draw valve arranged to control the flow rate of the draw stream to the draw side of the membrane;
a feed valve assembly comprising one or more valves, the feed valve assembly being operable to switch the direction of flow of the feed stream from a first direction to a second, opposite, direction by opening and/or shutting one or more of said valves;
a recirculation valve assembly comprising one or more valves, the recirculation valve assembly being operable to control the flow of at least part of the dilute draw stream to the inlet of the draw side by opening and/or shutting one or more of said valves; and
a control system configured to effect a change in the configuration of the osmotic system in order to provide at least part of the dilute draw stream to the draw side of the membrane in accordance with claim 23.
